(19) United States
(12) Patent Application Publication
(10) Pub. No.: US 2003/0025467 A1
(43) Pub. Date: Feb. 6, 2003

(54) Display apparatus and method for correcting electron beam landing pattern

(76) Inventors: Masanaga Tanaka, Kanagawa (JP); Hiromu Hosokawa, Chiba (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/207,212

(22) Filed: Jul. 30, 2002

(30) Foreign Application Priority Data
Jul. 31, 2001 (JP) P2001-232271
Oct. 5, 2001 (JP) P2001-310304

(51) Int. Cl. G09G 1/04

(52) U.S. Cl. 315/370

(57) ABSTRACT

A display apparatus according to the present invention includes an electron beam landing pattern correction coil disposed at the rear side of a deflection yoke provided on a cathode-ray tube and a correction current generating device for generating a correction current corresponding to an electron beam landing pattern and supplying the current to this electron beam landing pattern correction coil. This correction current is obtained by selectively combining a plurality of waveform current components (e.g., DC current component, a saw-tooth wave component, a parabolic waveform component, a sine waveform component, etc.) which can respectively correct a plurality of fundamental electron beam landing patterns in response to a difference in beam-landing position. Thus, after the display apparatus has been manufactured, the difference in beam-landing position of the manufactured display apparatus can be corrected to the details on the whole screen.

### BACKGROUND OF THE INVENTION

1. Field of the Invention

The present invention generally relates to a display apparatus capable of producing a high-quality image, and particularly to a method for correcting an electron beam landing pattern in a color cathode-ray tube of the display apparatus.

2. Description of the Related Art

In a color cathode-ray tube for use in a display apparatus such as a computer display, a difference occurs between the position of a phosphor layer in a fluorescent screen and the position at which an electron beam impinges upon the fluorescent screen. This difference is called a “difference in beam-landing position”. In general, the difference in beam-landing position can be decreased to the allowable range by optimizing factors regarding optical design such as shapes of lenses, the position of a light source and the like in a fluorescent screen exposure process of forming a fluorescent screen. Alternatively, the difference in beam-landing position can be corrected by other suitable methods such as attachment of a small magnet. Nevertheless, the difference in beam-landing position is caused by various factors such as accuracy in the assembly process of a color selection mechanism when a color cathode-ray tube is manufactured, a deformation of metal assemblies due to a thermal process, a deformation of glass due to an evacuation process, the design of a deflection yoke and the like.

Further, when the cathode-ray tube is operated, temperature change of the inside or outside of the cathode-ray tube causes the color selection mechanism and the like to be deformed because of heat, thereby the electron beam landing being changed. Moreover, due to the influence of the geomagnetic direction, an electron beam is deflected so that the electron beam landing may be changed. The change of the electron beam landing due to the influence of heat is referred to as a “temperature drift”. The change of the electron beam landing due to the influence of the geomagnetic is referred to as a “geomagnetic drift”.

The difference in beam-landing position due to these temperature drift, geomagnetic drift and the like have been so far corrected by an electron beam landing correction coil disposed on a body of CRT (cathode-ray tube) after the cathode-ray tube had been manufactured.

According to the above-mentioned correction means such as the electron beam landing correction coil or the magnet, a position to be corrected is limited, so that it is difficult to set the correction amount corresponding to each of coordinates on the screen.

### SUMMARY OF THE INVENTION

In view of the aforesaid aspect, it is an object of the present invention to provide a display apparatus in which the difference in electron beam landing position is corrected in detail over the whole screen and a method for correcting the electron beam landing pattern.

In a display apparatus according to the present invention, an electron beam landing pattern correction coil is disposed at the rear side of a deflection yoke provided on a cathode-ray tube, and a correction current in response to an electron beam landing pattern is supplied to this electron beam landing pattern correction coil. The correction current is supplied as correction current comprised of a plurality of selectively combined waveform current components which can respectively correct a plurality of fundamental electron beam landing patterns. Consequently, a difference in beam-landing position with respect to the manufactured display apparatus can be corrected in details over the whole screen.

In another display apparatus according to the present invention, electron beam landing pattern correction coils are disposed at the rear sides of respective deflection yokes provided on a multi-neck type cathode-ray tube including a plurality of electron guns, and correction current in response to electron beam landing patterns from a plurality of electron guns is supplied to the electron beam landing pattern correction coils. The correction current is comprised of a plurality of selectively combined waveform current components which can respectively correct a plurality of fundamental electron beam landing patterns, and respective electron beam landing patterns from a plurality of electron guns can be corrected independently. Accordingly, it becomes possible to adjust electron beam landing so that one phosphor is illuminated by a plurality of electron beams at an overlapping portion or the like on a screen.

In a method for correcting an electron beam landing pattern according to the present invention, a correction current comprised of a plurality of selectively combined waveform current components which can respectively correct a plurality of fundamental electron beam landing patterns is supplied to an electron beam landing pattern correction coil disposed at the rear side of the deflection yoke provided on a cathode-ray tube in response to an electron beam landing pattern. Thus, a difference in beam-landing position can be corrected in detail over the whole screen.

### BRIEF DESCRIPTION OF THE DRAWINGS

FIG. 1A is a diagram showing an arrangement of a color cathode-ray tube according to the present invention;

FIG. 1B is a perspective view schematically showing an electron beam landing pattern correction coil according to the present invention;

FIGS. 2A and 2B are cross-sectional views respectively taken along the line A-A in FIG. 1A, explaining force applied to an electron beam by magnetic fields;

FIG. 3 is a plan view of a screen, illustrating measurement points of measured value data;

FIGS. 4A through 4F are characteristic curve graphs showing current supplied to the electron beam landing pattern correction coil and the changes in electron beam landing at the respective measurement points in FIG. 3, respectively;

FIGS. 5A through 5F are characteristic curve graphs showing current supplied to the electron beam landing pattern correction coil and the changes in electron beam landing at the respective measurement points in FIG. 3, respectively;

FIG. 6A is a diagram showing a waveform of current flowing through the electron beam landing pattern correction coil for a purity correction;

FIG. 6B is a diagram explaining the manner in which the electron beam landing pattern is changed in response to the current shown in FIG. 6A;

FIG. 7A is a diagram showing a waveform of current flowing through the electron beam landing pattern correction coil for a rotation correction;

FIG. 7B is a diagram explaining the manner in which the electron beam landing pattern is changed in response to the current shown in FIG. 7A;

FIG. 8A is a diagram showing a waveform of current flowing through the electron beam landing pattern correction coil for a v-like correction;

FIG. 8B is a diagram explaining the manner in which the electron beam landing pattern is changed in response to the current shown in FIG. 8A;

FIG. 9A is a diagram showing a waveform of current flowing through the electron beam landing pattern correction coil for a DY (deflection yoke) position correction;

FIG. 9B is a diagram explaining the manner in which the electron beam landing pattern is changed in response to the current shown in FIG. 9A;

FIG. 10A is a diagram showing a waveform of current flowing through the electron beam landing pattern correction coil for a slanting line correction;

FIG. 10B is a diagram explaining the manner in which the electron beam landing pattern is changed in response to the current shown in FIG. 10A;

FIG. 11A is a diagram showing a waveform of a current flowing through the electron beam landing pattern correction coil for a barrel-like correction;

FIG. 11B is a diagram explaining the manner in which the electron beam landing pattern is changed in response to the current shown in FIG. 11A;

FIG. 12A is a diagram showing a waveform of current flowing through the electron beam landing pattern correction coil for an axis end shift correction;

FIG. 12B is a diagram explaining the manner in which the electron beam landing pattern is changed in response to the current shown in FIG. 12A;

FIG. 13A is a diagram showing a waveform of current flowing through the electron beam landing pattern correction coil for a twist correction;

FIG. 13B is a diagram explaining the manner in which the electron beam landing pattern is changed in response to the current shown in FIG. 13A;

FIG. 14A is a diagram showing a waveform of current flowing through the electron beam landing pattern correction coil for a corner shift correction;

FIG. 14B is a diagram explaining the manner in which the electron beam landing pattern is changed in response to the current shown in FIG. 14A;

FIG. 15A is a diagram showing a waveform of current flowing through the electron beam landing pattern correction coil for an S-like correction;

FIG. 15B is a diagram explaining the manner in which the electron beam landing pattern is changed in response to the current shown in FIG. 15A;

FIG. 16 is a schematic block diagram showing a correction current waveform generating device according to an embodiment of the present invention;

FIG. 17 is a schematic block diagram showing a correction current waveform generating device according to another embodiment of the present invention;

FIG. 18 is a schematic block diagram showing a correction current waveform generating device according to a further embodiment of the present invention;

FIG. 19 is a diagram showing a multi-neck type color cathode-ray tube according to an embodiment of the present invention; and

FIG. 20 is a schematic plan view showing a panel portion of a cathode-ray tube, and to which reference will be made in explaining the present invention.

### DESCRIPTION OF THE PREFERRED EMBODIMENTS

With reference to the drawings, preferred embodiments according to the present invention will be described below.

[First embodiment]

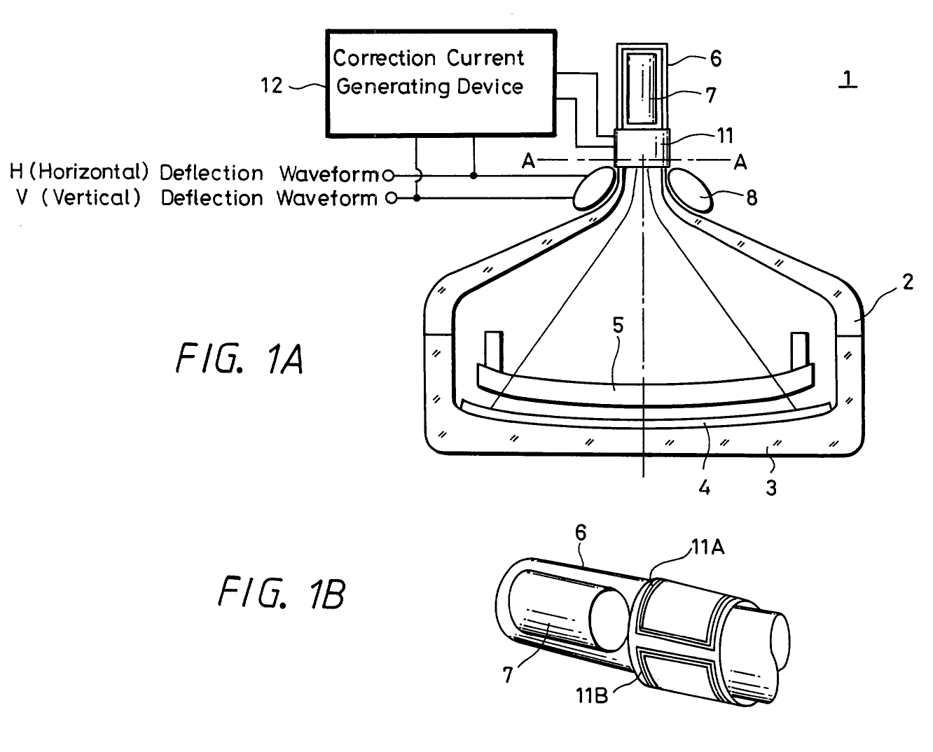

In a color cathode-ray tube 1 according to an embodiment of the present invention, a color fluorescent screen 4 comprising a plurality of color phosphor layers, that is red (R), green (G) and blue (B) phosphor layers in this embodiment, is formed on the inner surface of a panel 3 of the body 2 of CRT as shown in FIG. 1A. A color selection mechanism 5 is disposed closely opposing to this color fluorescent screen 4. An electron gun 7 is disposed within a neck portion 6, and a deflection yoke (DY) 8 is disposed at the outside of the body 2 of CRT.

In this embodiment, in particular, an electron beam landing pattern correction coil (so-called electromagnetic coil) 11 is disposed at the rear side of the deflection yoke 8. A correction current generating device 12 for generating a correction current (so-called waveform current) having a period synchronized with that of the deflection yoke 8 in which an electron beam is deflected, is connected to the electron beam landing pattern correction coil 11.

A signal waveform of a deflection period in the line direction of the electron beam and a signal waveform of a deflection period in the field direction of the electron beam are supplied to the deflection yoke 8 and the correction current generating device 12. The electron beam landing pattern correction coil 11 may be shaped without restraint so long as such coil can generate a magnetic field near the central axis of the neck portion 6 in the direction approximately vertical to the direction in which an electron beam landing pattern is to be changed on the screen. In this embodiment, as shown in FIG. 1B, a pair of electromagnetic coils 11A and 11B are mounted opposing to each other across the neck portion 6 to constitute the electron beam landing pattern correction coil 11.

In response to electron beam landing patterns, a correction current comprising a plurality of selectively combined waveform current components capable of correcting a plurality of fundamental electron beam landing patterns, is supplied to the electron beam landing pattern correction coil 11 from the correction current generating device 12.

In this embodiment, a display apparatus such as a computer display, a display of a television receiver or the like is constructed with the above-mentioned color cathode-ray tube 1 being assembled as a unit.

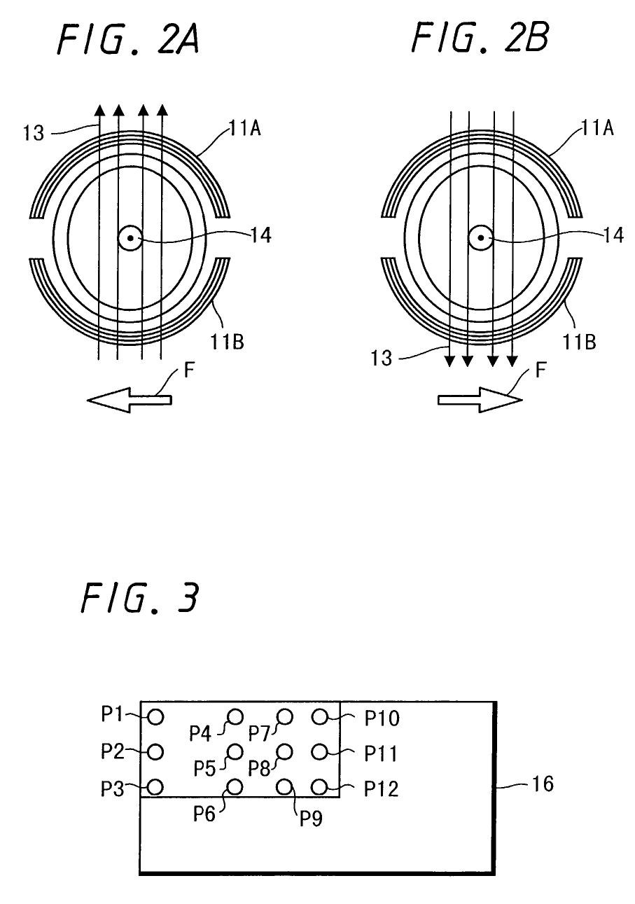

When a current is supplied to the above-described electron beam landing pattern correction coil 11 (comprising 11A, 11B), as shown in FIGS. 2A and 2B, the coil 11 generates magnetic field 13. The directions of magnetic fields 13 in FIGS. 2A and 2B are opposite due to the difference in directions of the current. The strength of the magnetic field 13 is determined in proportion to the current intensity which flows through the correction coils 11 (comprising 11A, 11B). The strength of the magnetic field 13 is approximately uniform around the central axis of the neck portion 6, and an electron beam 14 passing by the axis receives force F which is proportional to the strength of the magnetic field 13, thereby the path of the electron beam 14 being deflected. A degree to which the electron beam 14 is deflected is proportional to the above-described force F. Accordingly, the electron beam path is deflected in proportion to the current intensity which flows through the correction coil 11.

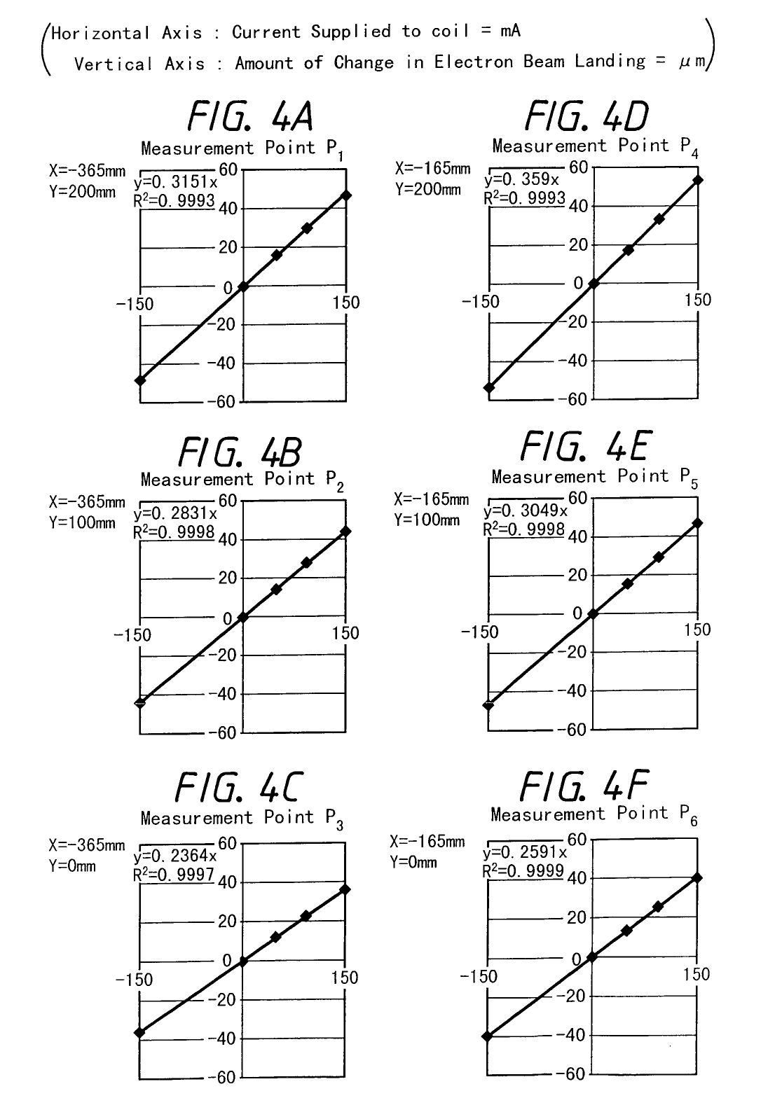

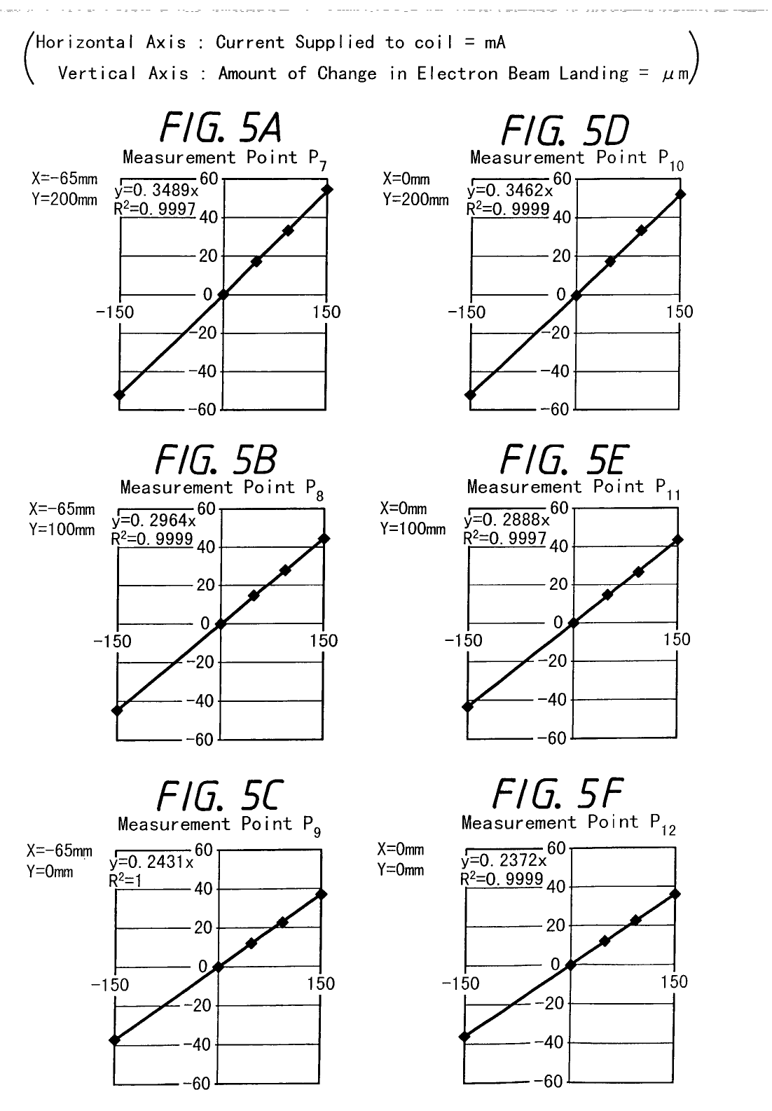

FIGS. 4A to 4F and FIGS. 5A to 5F are diagrams illustrating measured value data in which the amount of change in electron beam landing is shown, when an arbitrary intensity of current is supplied to the electron beam landing pattern correction coil 11 of the cathode-ray tube 1 according to the embodiment of the present invention. In this embodiment, a 36-inch cathode-ray tube was used and 12 points P1 to P12 in the second quadrant on a screen 16 were employed as measurement points. The measured value data in FIGS. 4A to 4F and FIGS. 5A to 5F confirmed that there is recognized an extremely strong linear correlation in the relationship between the current intensity and the amount of change in the electron beam landing in all the measurement points P1 to P12. In FIGS. 4A to 4F and FIGS. 5A to 5F, reference letter R² denotes a correlation coefficient and its value is preferred to be close to “1” as much as possible.

In this embodiment, when the value of electron beam landing is calculated at an arbitrary point on the screen without the electron beam landing pattern correction function, electron beam landing can be adjusted at all points on the screen by supplying an appropriate intensity of current to the coil on the basis of the correlation relationships shown in FIGS. 4A to 4F and FIGS. 5A to 5F. Specifically, electron beam landing at all points on the screen can be adjusted by supplying an appropriate intensity of current corresponding to such arbitrary points to the electron beam landing pattern correction coil 11, while an electron beam is displaying an arbitrary point on the screen.

Generally, a device for generating a current to correct an arbitrary amount of electron beam landing at an arbitrary point tends to be expensive and to have a complex circuit configuration. However, in actual practice, it is observed that an electron beam landing to be corrected in a cathode-ray tube frequently falls within certain patterns. In that case, since the necessary correction current should be certain patterns, such correction current generating device can be manufactured relatively easily.

The correction current generating device 12 according to this embodiment generates a DC current (zeroth-order relative to time axis) synchronized with the deflections in the line direction and field direction of the electron beam, a sawtooth waveform (first-order relative to time axis), parabolic waveform (second-order relative to time axis) and a sine waveform to output a combination of the aforementioned waveforms. According to this embodiment, certain patterns of electron beam landing can be corrected by supplying an output current from this correction current generating apparatus 12 to the electron beam landing pattern correction coil 11.

Let us herein define the line direction as “a direction in which one line is scanned by an electron beam” and the field direction as “a direction in which the scanned electron beam then scans as a field, that is, a direction perpendicular to the line direction.” Accordingly, in the case of the cathode-ray tube shown in FIGS. 1A and 1B, for example, the line direction represents a horizontal (H) direction on the screen and the field direction represents a vertical (V) direction on the screen. In the case of the later described multi-neck type cathode-ray tube 21, since an electron beam scans in the vertical direction on the screen and then scans in the vertical direction on the screen, a line direction represents the vertical direction on the screen and a field direction represents the horizontal direction on the screen.

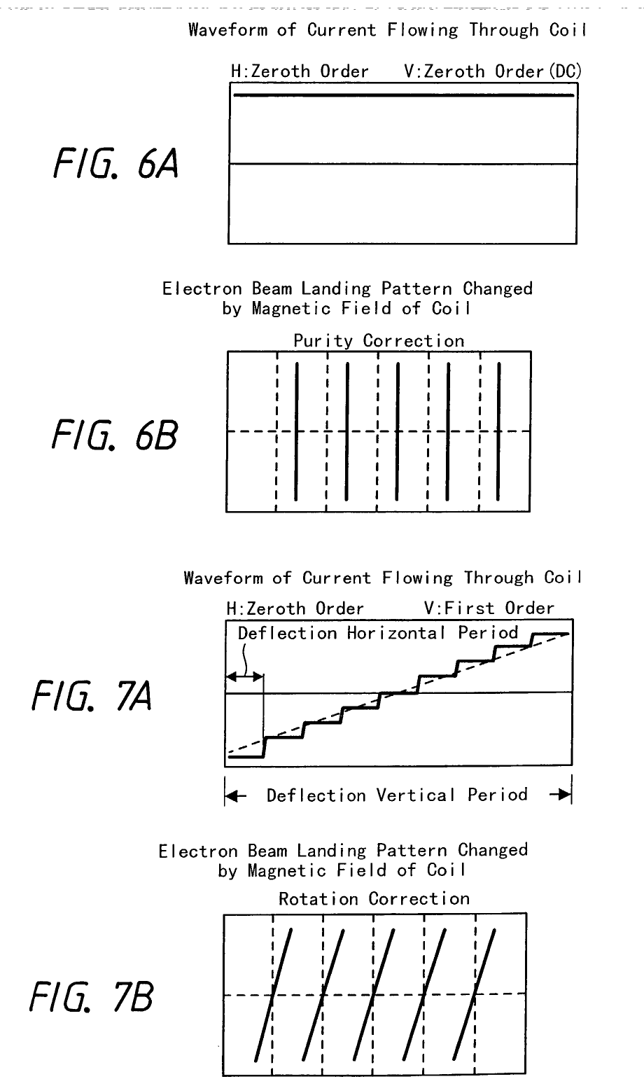

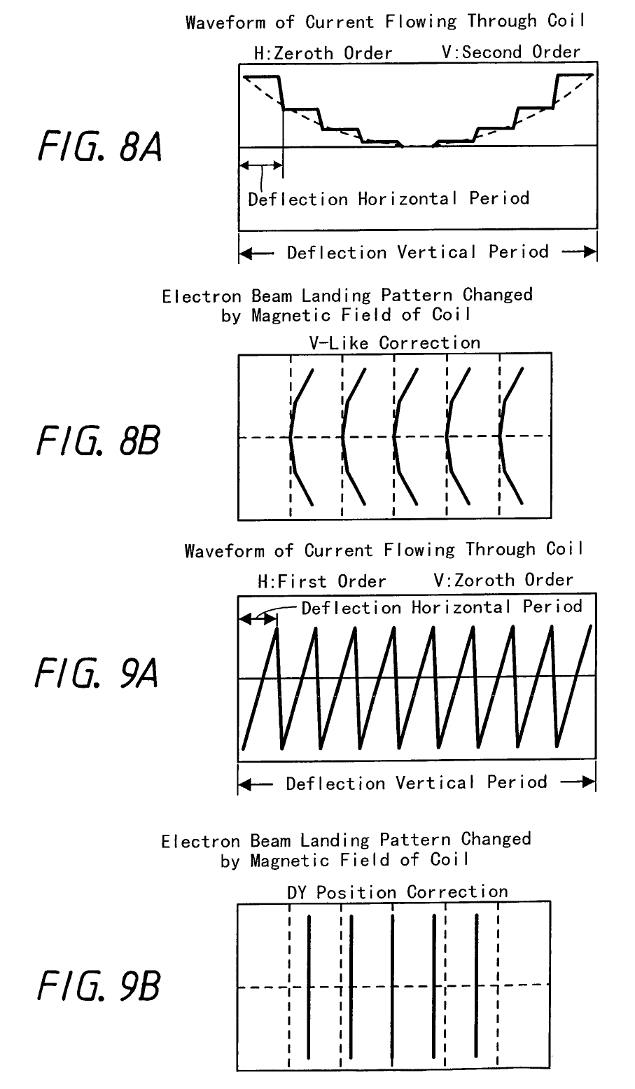

FIGS. 6A, 6B to FIGS. 15A, 15B are diagrams showing the manner in which a electron beam landing pattern is changed on the whole screen, when a certain pattern of current synchronized with a deflection period is supplied to the electron beam landing pattern correction coil 11. In this embodiment, ten sets of patterns are assumed to be fundamental correction pattern components. The correction patterns shown in FIGS. 6B through FIGS. 15B are obtained when the cathode-ray tube 1 shown in FIGS. 1A and 1B is applied. Throughout FIGS. 6A, 6B to FIGS. 15A, 15B, reference letter H denotes a horizontal direction on a screen, and reference letter V denotes a vertical direction on a screen.

FIGS. 6A and 6B are diagrams showing the change in the electron beam landing pattern caused by the magnetic field of the correction coil (see FIG. 6B), when a waveform of the current supplied to the correction coil 11 is in the zeroth order both in the horizontal direction (H: zeroth order) and in the vertical direction (V: zeroth order (DC) (see FIG. 6A). In this case, as shown in FIG. 6B, the electron beam landing pattern shifts from positions described with solid-line to positions described with dashed-line on the screen to carry out so-called “purity correction”.

FIGS. 7A and 7B are diagrams showing the change in the electron beam landing pattern caused by the magnetic field of the correction coil (see FIG. 7B), when a waveform of the current supplied to the correction coil 11 is in the zeroth order in the horizontal direction (H: 0-th order) and in the first order in the vertical direction (V: first order) (see FIG. 7A). In this case, as shown in FIG. 7B, the electron beam landing pattern shifts from positions described with solid-line to positions described with dashed-line on the screen to carry out so-called “rotation correction”.

FIGS. 8A and 8B are diagrams showing the change in the electron beam landing pattern caused by the magnetic field of the correction coil (see FIG. 8B), when a waveform of current supplied to the correction coil 11 is in the zeroth order in the horizontal direction (H: 0-th order) and in the second order in the vertical direction (V: second order) (see FIG. 8A). In this case, as shown in FIG. 8B, the electron beam landing pattern shifts from positions described with solid-line to positions described with dashed-line on the screen to carry out so-called “V-like correction”.

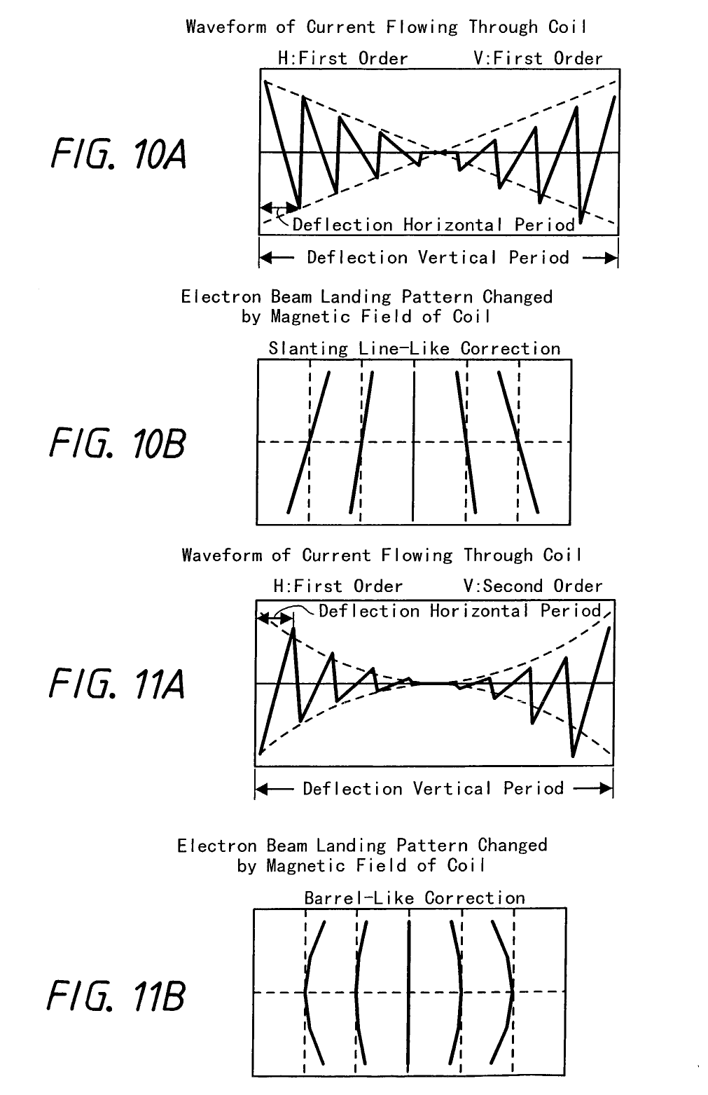

FIGS. 9A and 9B are diagrams showing the change in the electron beam landing pattern caused by the magnetic field of the correction coil (see FIG. 9B), when a waveform of current supplied to the correction coil 11 is in the first order in the horizontal direction (H: first order) and in the zeroth order in the vertical direction (V: zeroth order) (see FIG. 9A). In this case, as shown in FIG. 9B, the electron beam landing pattern shifts from positions described with solid-line to positions described with dashed-line on the screen to carry out so-called “DY position correction”.

FIGS. 10A and 10B are diagrams showing the change in the electron beam landing pattern caused by the magnetic field of the correction coil (see FIG. 10B), when a waveform of current supplied to the correction coil 11 is in the first order in the horizontal direction (H: first order) and in the first order in the vertical direction (V: first order) (see FIG. 10A). In this case, as shown in FIG. 10B, the electron beam landing pattern shifts from positions described with solid-line to positions described with dashed-line on the screen to carry out so-called “slanting line-like correction”.

FIGS. 11A and 11B are diagrams showing the change in the electron beam landing pattern caused by the magnetic field of the correction coil (see FIG. 11B), when a waveform of current supplied to the correction coil 11 is in the first order in the horizontal direction (H: first order) and in the second order in the vertical direction (V: second order) (see FIG. 11A). In this case, as shown in FIG. 11B, the electron beam landing pattern shifts from positions described with solid-line to positions described with dashed-line on the screen to carry out so-called “barrel-like correction”.

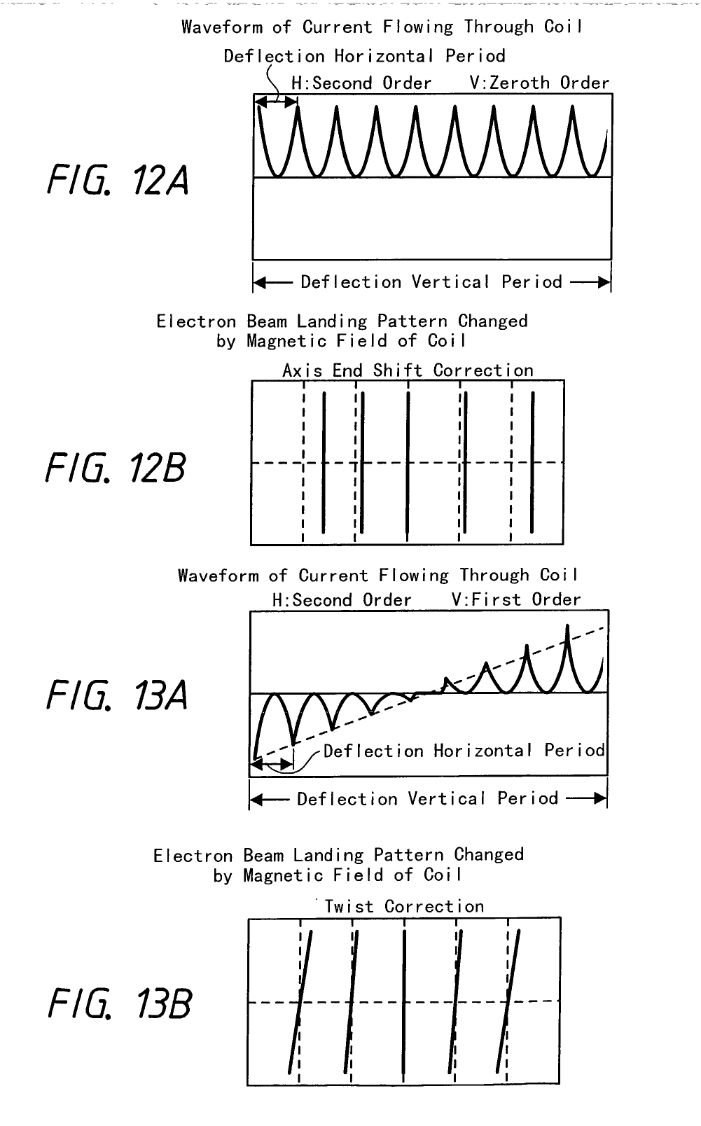

FIGS. 12A and 12B are diagrams showing the change in the electron beam landing pattern by the magnetic field of the correction coil (see FIG. 12B), when a waveform of current supplied to the correction coil 11 is in the second order in the horizontal direction on the screen (H: second order) and in the zeroth order in the vertical direction on the screen (V: zeroth order) (see FIG. 12A). In this case, as shown in FIG. 12B, the electron beam landing pattern shifts from positions described with solid-line to positions described with dashed-line on the screen to carry out so-called “axis end shift correction”.

FIGS. 13A and 13B are diagrams showing the change in the electron beam landing pattern caused by the magnetic field of the correction coil (see FIG. 13B), when a waveform of current supplied to the correction coil 11 is in the second order in the horizontal direction (H: second order) and in the first order in the vertical direction (V: first order) (see FIG. 13A). In this case, as shown in FIG. 13B, the electron beam landing pattern shifts from positions described with solid-line to positions described with dashed-line on the screen to carry out so-called “twist correction”.

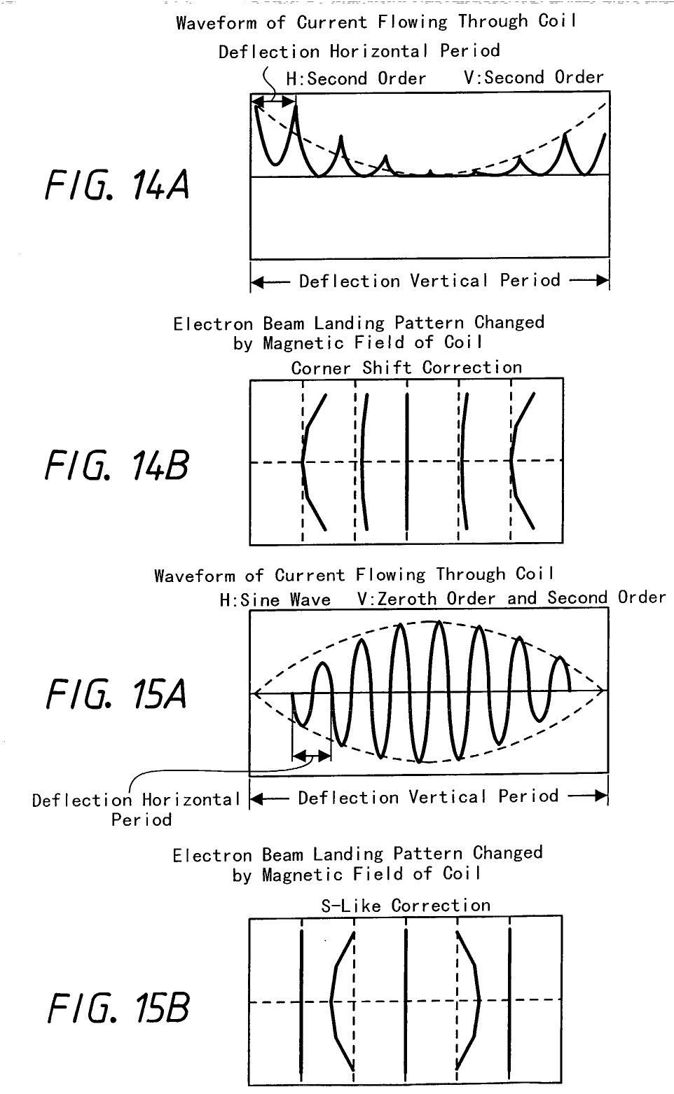

FIGS. 14A and 14B are diagrams showing the change in the electron beam landing pattern caused by the magnetic field of the correction coil (see FIG. 14B), when a waveform of current supplied to the correction coil 11 is in the second order in the horizontal direction (H: second order) and in the second order in the vertical direction (V: second order) (see FIG. 14A). In this case, as shown in FIG. 14B, the electron beam landing pattern shifts from positions described with solid-line to positions described with dashed-line on the screen to carry out so-called “corner shift correction”.

FIGS. 15A and 15B are diagrams showing the change in the electron beam landing pattern caused by the magnetic field of the correction coil (see FIG. 15B), when a waveform of current supplied to the correction coil 11 is a sine wave in the horizontal direction on the screen (H: sine wave) and in the zeroth order and the second order in the vertical direction (V: zeroth order and second order) (see FIG. 15A). In this case, as shown in FIG. 15B, the electron beam landing pattern shifts from positions described with solid-line to positions described with dashed-line on the screen to carry out so-called “S-like correction”.

According to this embodiment, a certain beam-landing pattern is regarded as a combination of components of beam-landing patterns shown in FIGS. 6B to 15B, and combined waveform current components of patterns shown in FIGS. 6A to 15A are supplied to the electron beam landing pattern correction coil 11, thereby simultaneously correcting various patterns of the electron beam landing. Since the current intensity supplied to the correction coil 11 can be adjusted, an absolute amount of the electron beam landing can be determined freely.

This embodiment is also applied to correcting the change in electron beam landing due to heat, i.e., a temperature drift. In this case, a temperature drift at an arbitrary point on the screen has been examined in advance, and an integrated value of a cathode current is observed when the cathode-ray tube is being operated. According to this embodiment, a correction current to the electron beam landing pattern correction coil 11 is appropriately changed in response to the integrated value of operating time and the cathode current, thereby the appropriate value of correction current being maintained on the whole screen. In most cases, the temperature drift contains components of the purity correction, rotation, slanting-line, barrel-like and twist shown in FIGS. 6B, 7B, 10B, 11B and 13B respectively. Therefore, the temperature drift can be corrected by supplying a correction current selectively combined the waveform current components to correct these components, to the electron beam landing pattern correction coil 11.

This embodiment is also applied to the change in electron beam landing due to geomagnetism, i.e., a geomagnetic drift. In this case, a geomagnetic drift at an arbitrary point on the screen has been examined in advance, and an azimuth of the cathode-ray tube is detected by suitable means such as a geomagnetic sensor. According to this embodiment, a correction current to the electron beam landing pattern correction coil 11 is appropriately changed in response to the azimuth of the cathode-ray tube, thereby the appropriate value of correction current being maintained on the whole screen. In most cases, the geomagnetic drift contains components of the purity correction and rotation shown in FIGS. 6B and 7B respectively. Therefore, the geomagnetic drift can be corrected by supplying a correction current selectively combined the waveform current components to correct these components, to the electron beam landing pattern correction coil 11.

Note that according to this embodiment, a place displayed by an electron beam is changed (so-called picture distortion is changed) as well as the electron beam landing pattern to be corrected. Accordingly, the picture distortion requires being adjusted under the condition in which the cathode-ray tube according to this embodiment is being operated. Further, a current supplied to the electron beam landing pattern correction coil 11 requires being determined considering in advance that the display position will be shifted.

Next, the correction current generating device 12 according to an embodiment of the present invention will be described.

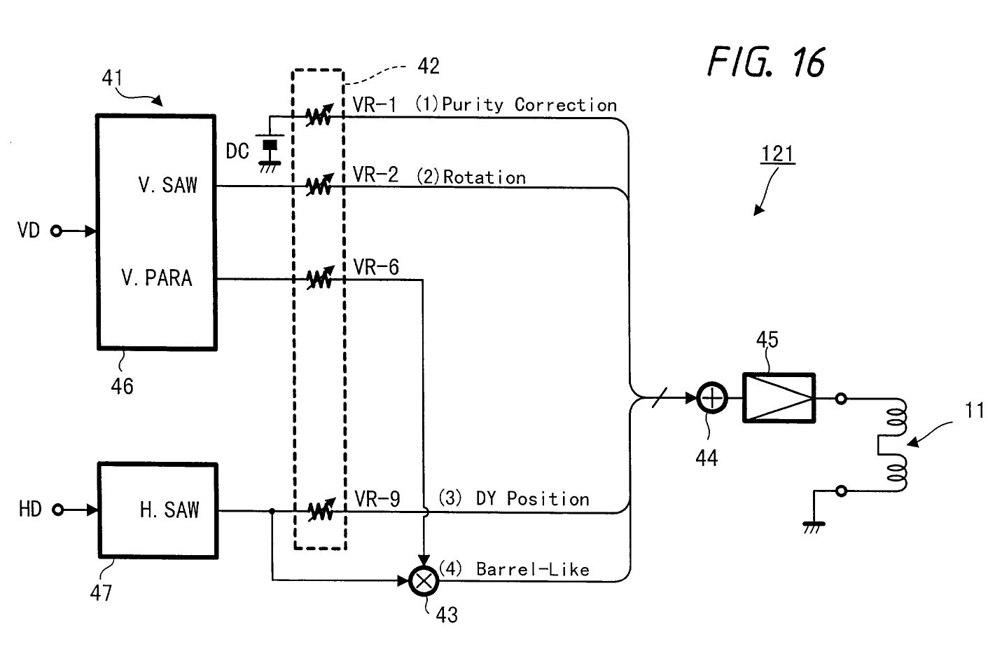

FIG. 16 is a schematic block diagram showing a circuit arrangement in which four fundamental correction waveform components (so-called waveform current patterns) are generated to supply a correction current in the case where a relatively simple and fundamental correction is conducted.

As shown in FIG. 16, a correction current generating device 121 according to the embodiment includes a waveform generating circuit 41 for generating fundamental correction waveform components synchronized with a deflection frequency, a ratio adjusting circuit 42 for adjusting a ratio of respective correction waveform components, an amplitude modulator 43, an adder 44 and a power amplifier 45. The waveform generating circuit 41 includes a field period waveform generating circuit 46 (vertical (V) period waveform generating circuit in the example shown in FIG. 1) and a line period waveform generating circuit 47 (horizontal (H) period waveform generating circuit in the example shown in FIG. 1).

A vertical drive signal VD is inputted to the vertical period waveform generating circuit 46 to generate a vertical period saw-tooth wave (V. SAW) and a vertical period parabolic wave (V. PARA), which serve as fundamental waveform components. A horizontal drive signal HD is inputted to the horizontal period waveform generating circuit 47 to generate a horizontal period sawtooth wave (H. SAW), which serves as a fundamental waveform component.

The ratio adjusting circuit 42 is comprised of four variable resistors VR (VR-1, VR-2, VR-6, and VR-9). One end of the first variable resistor VR-1 is connected to a DC power supply DC, one end of the second variable resistor VR-2 is connected to an output end of the vertical period saw-tooth wave (V. SAW), one end of the third variable resistor VR-6 is connected to the vertical period parabolic wave (V. PARA), and one end of the fourth variable resistor VR-9 is connected to an output end of the horizontal period sawtooth wave (H. SAW).

Further, the other end of the first variable resistor VR-1, the other end of the second variable resistor VR-2, the other end of the fourth variable resistor VR-9 and the output end of the amplitude modulator 43 are connected to the input section of the adder 44. The output from the adder 44 is supplied through the power amplifier 45 to the electron beam landing pattern correction coil 11.

In the correction current waveform generating device 121, a current waveform to correct a purity component is obtained as a DC current from the DC power supply DC (1). A current waveform to correct a rotation component is obtained as a vertical period waveform (V. SAW) (2). A current waveform to correct a DY position component is obtained as a vertical period parabolic wave (V. PARA) (4). A current waveform to correct a barrel-like component is obtained as a waveform of a horizontal period sawtooth wave (H. SAW) amplitude-modulated by the vertical period parabolic wave (V. PARA) (6).

According to the embodiment, current waveform is decomposed into the above-described respective fundamental correction waveform components (current waveform components) (1), (2), (4), and (6) in response to the predetermined electron beam landing pattern occurred in the cathode-ray tube 1. The respective correction components obtained by adjusting the ratio of the current of the respective fundamental correction waveform components in the respective variable resistors VR (VR-1, VR-2, VR-6, VR-9) are selectively combined in the adder 44, thereby the correction current waveform corresponding to the above-described predetermined electron beam landing pattern being obtained. This correction current waveform is amplified in power by the power amplifier 45 to supply to the electron beam landing pattern correction coil 11, thereby the electron beam landing pattern being corrected dynamically. Specifically, the electron beam landing pattern can be made appropriate to all coordinates on the screen. As the power amplifier 45, there may be employed a power amplifier of a linear amplifier system or a power amplifier of a switching amplifier system.

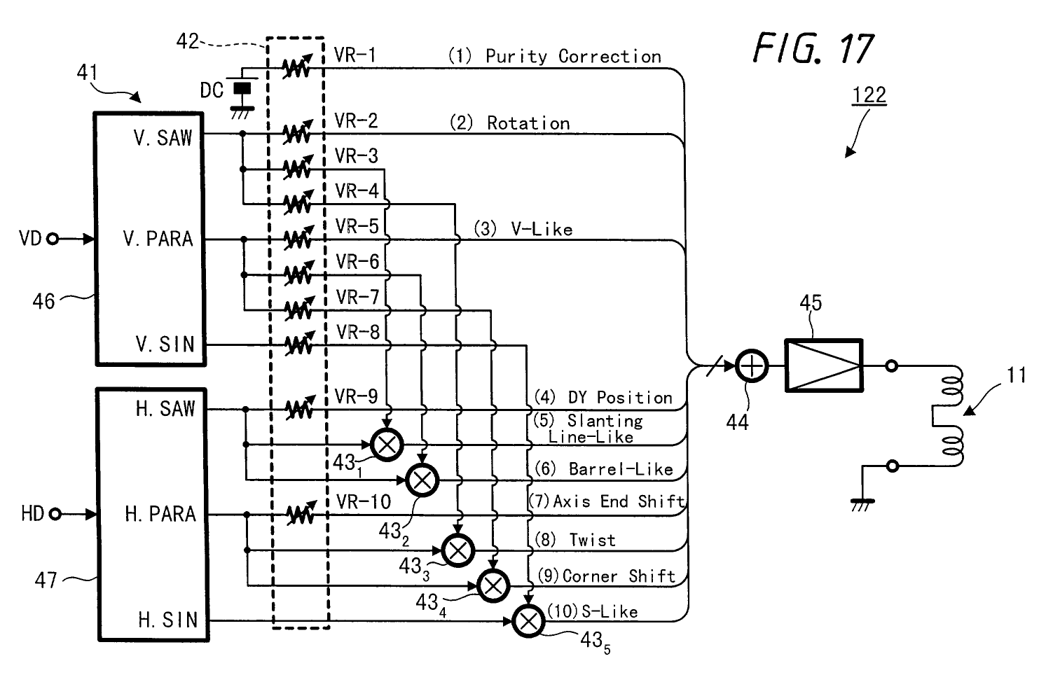

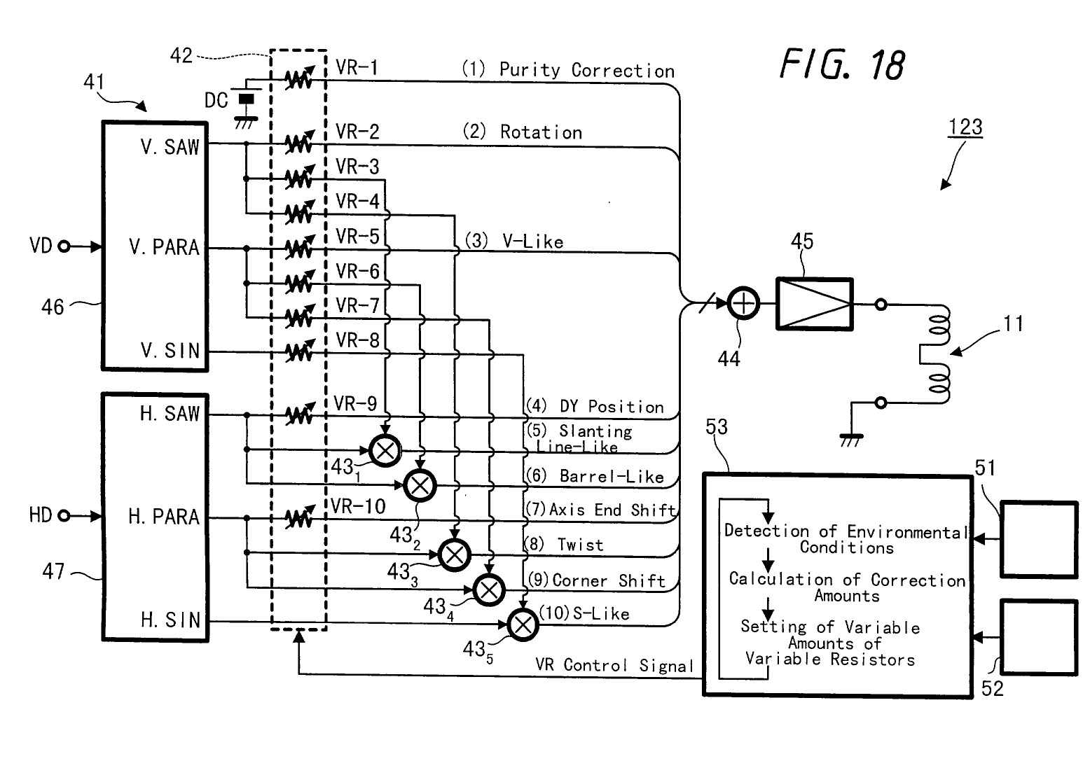

FIG. 17 is a schematic block diagram showing another embodiment of correction current waveform generating device according the present invention. FIG. 17 shows an example in which the number of fundamental correction waveform components is increased to ten kinds.

As shown in FIG. 17, the correction current waveform generating device 122 according to this embodiment comprises the waveform generating circuit 41 for generating fundamental correction waveform components synchronized with a deflection frequency, the ratio adjusting circuit 42 for adjusting ratios of the respective correction waveform components, a plurality of amplitude modulators, in this embodiment, five amplitude modulators 43 (43₁, 43₂, 43₃, 43₄, and 43₅), an adder 44 and a power amplifier 45. The waveform generating circuit 41 includes the field period waveform generating circuit 46 (vertical (V) period waveform generating circuit in the example shown in FIG. 1) and the line period waveform generating circuit 47 (horizontal (H) period waveform generating circuit in the example shown in FIG. 1).

A vertical drive signal VD is inputted to the vertical period waveform generating circuit 46 to generate a vertical period saw-tooth wave (V. SAW), a vertical period parabolic wave (V. PARA), and vertical period sine wave (V. SIN), which serve as fundamental correction waveform components. A horizontal drive signal HD is inputted to the horizontal period waveform generating circuit 47 to generate a horizontal period saw-tooth wave (H. SAW), horizontal period parabolic wave (H. PARA), and horizontal period sine wave (H. SIN), which serve as fundamental correction waveform components.

The ratio adjusting circuit 42 is comprised of ten variable resistors VR (VR-1, VR-2, VR-3, VR-4, VR-5, VR-6, VR-7, VR-8, VR-9, and VR-10).

The other end of the third variable resistor VR-3 and the output end of the horizontal period saw-tooth wave (H. SAW) are connected to the input section of the first amplitude modulator 431. The other end of the sixth variable resistor VR-6 and the output end of the horizontal period saw-tooth (H. SAW) are connected to the input section of the second amplitude modulator 43₂. The other end of the fourth variable resistor VR-4 and the output end of the horizontal period parabolic wave (H. PARA) are connected to the input section of the third amplitude modulator 43₃. The other end of the seventh variable resistor VR-7 and the output end of the horizontal period parabolic wave (H. PARA) are connected to the input section of the fourth amplitude modulator 43₄. The other end of the eighth variable resistor VR-8 and the output end of the horizontal period sine wave (H. SIN) are connected to the input section of the fifth amplitude modulator 43₅.

Further, the other end of the first variable resistor VR-1, the other end of the second variable resistor VR-2, the other end of the fifth variable resistor VR-5, the other end of the ninth variable resistor VR-9 and the respective output ends of the first, second, third, fourth and fifth amplitude modulators 43₁, 43₂, 43₃, 43₄ and 43₅ are connected to the input section of the adder 44. The output from the adder 44 is amplified in power by the power amplifier 45 and supplied to the electron beam landing pattern correction coil 11.

In this correction current waveform generating device 122, a curuit waveform to correct the purity correction is obtained as a DC current from the DC power supply DC. A current waveform to correct the rotation component is obtained as the vertical period sawtooth wave (V. SAW). A current waveform to correct the V-like component is obtained as the vertical period parabolic wave (V. PARA). A current waveform to correct the DY position component is obtained as the horizontal sawtooth wave (H. SAW). A current waveform to correct the slanting line-like component is obtained as the horizontal period sawtooth wave (H. SAW) amplitude-modulated by the vertical period sawtooth wave (V. SAW). A current waveform to correct the barrel-like component is obtained as the horizontal period sawtooth wave (H. SAW) amplitude-modulated by the vertical period parabolic wave (V. PARA). A current waveform to correct the axis end shift component is obtained as the horizontal period parabolic wave (H. PARA). A current waveform to correct the twist component is obtained as the horizontal period parabolic wave (H. PARA) amplitude-modulated by the vertical period sawtooth wave (V. SAW). A current waveform to correct the corner shift component is obtained as the horizontal period parabolic wave (H. PARA) amplitude-modulated by the vertical period parabolic wave (V. PARA). A current waveform to correct the S-like component is obtained as the horizontal period sine wave (H. SIN) amplitude-modulated by the vertical period sine wave (V. SIN).

According to the embodiment, the current waveform is decomposed into the above-described respective fundamental correction waveform components (current waveform components) (1) to (10) in response to the predetermined electron beam landing pattern occurred in the cathode-ray tube 1. The respective correction components obtained by adjusting the ratio of the current of the respective fundamental correction waveform components in the respective variable resistors VR (VR-1 to VR-10) are selectively combined in the adder 44, thereby the correction current waveform corresponding to the above-described predetermined electron beam landing pattern being obtained. This correction current waveform is amplified in power by the power amplifier 45 to supply to the electron beam landing pattern correction coil 11, thereby the electron beam landing pattern being corrected dynamically. Specifically, the electron beam landing pattern can be made appropriate to all coordinates on the screen.

Since the resistance values of the variable resistors are not set automatically in the embodiments shown in FIGS. 16 and 17, the electron beam landing will be deteriorated on the basis of the change of environmental conditions (e.g., direction of cathode-ray tube and temperatures inside or outside of the cathode-ray tube) in the case where this correction current generating device is applied to a display apparatus such as a television receiver, computer display or the like without modifications.

FIG. 18 is a schematic block diagram showing another embodiment in which the above-mentioned defect can be improved. This correction current waveform generating device is what might be called a digitally-controlled correction current waveform generating device.

As shown in FIG. 18, a correction current waveform generating device 123 according to this embodiment comprises, in addition to the correction current waveform generating device 122 shown in FIG. 17, a geomagnetic sensor 51, a cathode current (Ik) detecting circuit 52 and a microcomputer 53. The geomagnetic sensor 51 is incorporated within a display apparatus, although not shown. The azimuth of the cathode-ray tube can be detected by the geomagnetic sensor 51 with ease. The temperature drift of the cathode-ray tube can be estimated from an integrated value obtained after the cathode current detecting circuit 52 has detected the cathode current (Ik).

Detected information from the geomagnetic sensor 51 and detected information from the cathode current detecting circuit 52 are inputted to the microcomputer 53. The microcomputer 53 is able to detect environmental conditions, able to calculate the amount of correction and able to set resistance values of the respective variable resistors VR. The variable amounts of the respective variable resistors VR in the ratio adjusting circuit 42 can be controlled based upon a variable amount control signal (VR control signal) of the variable resistors VR from this microcomputer 53.

According to the display apparatus including the correction current waveform generating device 123 according to the embodiment, information on environmental conditions is inputted to the microcomputer 53 to calculate the amount of correction, thereby the resistance values of the respective variable resistors VR being set automatically. Further, the electron beam landing can constantly be corrected to become optimum by repeating these operations during the display apparatus is being operated.

As described above, according to the embodiment of the present invention, the difference in a certain beam-landing pattern generated in the display apparatus including the cathode-ray tube 1 can be appropriately corrected regarding all coordinates on the screen by a desired amount.

In accordance with the optical design required when a fluorescent screen is produced, the electron beam landing of the display apparatus cannot be corrected after the display apparatus has been manufactured. However, according to this embodiment, the electron beam landing can be corrected after the display apparatus has been manufactured. Further, since the amount of correction is adjusted in accordance with each cathode-ray tube after the cathode-ray tube has been manufactured, it becomes possible to adjust dispersions in the process of manufacturing the cathode-ray tubes.

By employing the electron beam landing pattern correction method according to this embodiment, the optical design required when a fluorescent screen is produced can be simplified. Specifically, since a curvature of an exposure lens can be simplified and the number of lens required for exposure systems can be reduced, accuracy of the exposure lens can be increased. Furthermore, designing of a deflection yoke can be simplified.

[Second embodiment]

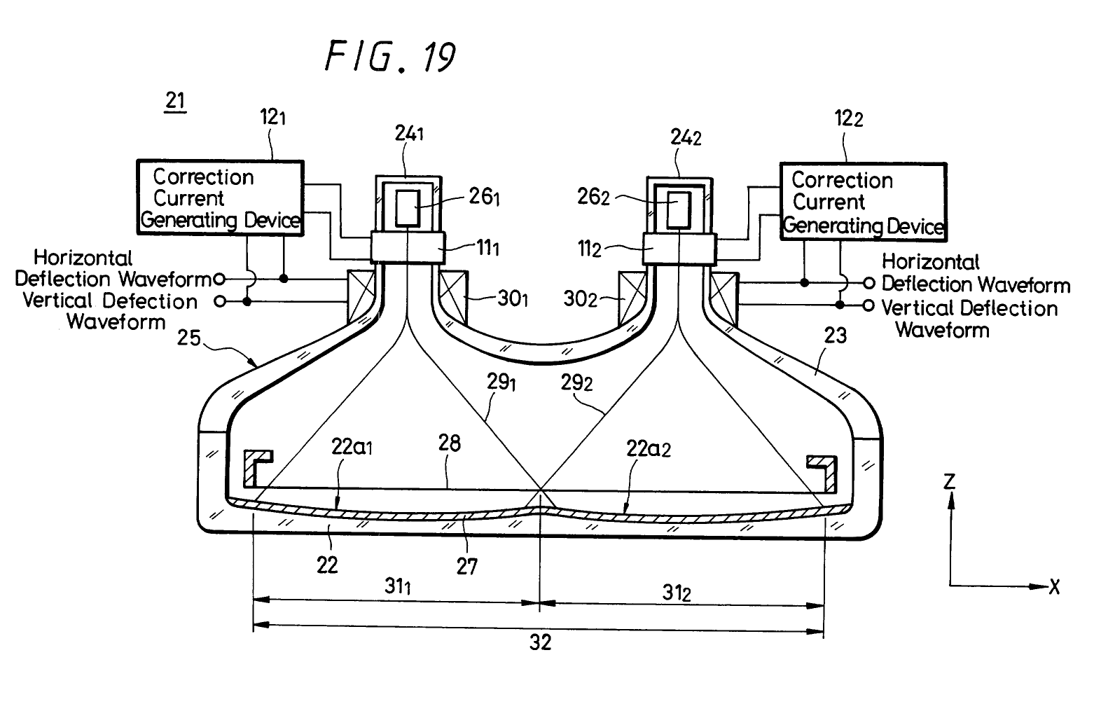

FIG. 19 is a schematic diagram showing a color cathode-ray tube for use in the display apparatus according to another embodiment of the present invention. In this embodiment, the present invention is applied to a so-called multi-neck type color cathode-ray tube.

A color cathode-ray tube 21 according to this embodiment includes a plurality of neck portions, in this embodiment, two neck portions 24 (24₁, 24₂) which incorporate therein two electron guns 26 (26₁, 26₂), respectively. Specifically, there is provided a body of CRT 25 which is comprised of a panel portion 22 forming a large screen area, a funnel portion 23 joined to this panel portion 22 and the two neck portions 24 (24₁, 24₂) joined to this funnel portion 23. The electron guns 26₁ and 26₂ are respectively disposed within the two neck portions 24₁ and 24₂. In connection with this, a color selection mechanism 28 such as an aperture grill and a shadow mask is disposed opposing to a color fluorescent screen 27 formed on the inner surface of the panel portion 22. This cathode-ray tube 21 is adapted to display the entire image on a large image area formed by combining a plurality of small image areas, in this embodiment, two image areas. Deflection yokes 30 (30₁, 30₂) are mounted around the outside of the body of the CRT 25 in a range from the two neck portions 24₁, 24₂ to the funnel portion 23.

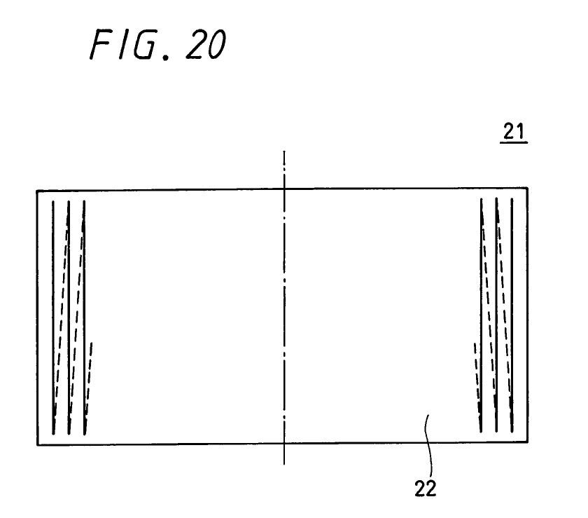

As shown in FIG. 20, the panel portion 22 is integrally molded and formed as a rectangular shape in which the horizontal direction of the screen is assumed to be a major axis and the vertical direction of the screen is assumed to be a minor axis. On the inner surface of the panel portion 22, there are formed a plurality of small image areas 31 scanned by electron beams emitted from the respective electron guns 26, the number of which corresponds to the number of the electron guns 26. In this embodiment, there are formed the two small image areas 31₁ and 31₂, and the large image area 32 is formed by synthesizing the two small image areas 31₁ and 31₂. In this embodiment, electron beams 29₁, 29₂ from the two electron guns 26₁, 26₂ are configured to scan small image areas 31₁, 31₂ adjacent to each other in a partly overlapping fashion, i.e., to scan near the boundary between the two small image areas 31₁ and 31₂. The color selection mechanism 28 works for the large image area 32 of the panel portion 22.

In this twin-neck type color cathode-ray tube 21, the electron beams 29₁, 29₂ from the respective electron guns 26₁, 26₂ are emitted so as to display an approximate half of an image on the screen. The electron beams 29₁, 29₂ scan the vertical direction of the screen in a line scanning fashion, and scan the horizontal direction of the screen from the end of the screen to the center of the screen (or from the center of the screen to the end of the screen) in a field scanning fashion and a part of areas are overlapping around the center of the screen. In this cathode-ray tube 21, the vertical deflection of the electron beams 29₁, 29₂ corresponds to a so-called line deflection and the horizontal deflection corresponds to a so-called field deflection.

In the twin-neck type color cathode-ray tube 21, the two electron beams 29₁, 29₂ are required to impinge upon the same phosphor layer on the central area of the large image area 32. To this end, two electron beams should be controlled independently to correct the electron beam landing pattern.

In this embodiment, the color cathode-ray tube 21 includes, as shown in FIG. 19, electron beam landing correction coils (so-called electromagnetic coils) 11₁, 11₂ disposed at the rear sides of the deflection yokes 30₁, 30₂ on the outsides of the respective neck portions 24₁, 24₂ and correction current generating devices 12₁, 12₂ for supplying correction currents (so-called waveform currents) having the period synchronized with the deflection of the electron beams by the deflection yokes 30₁, 30₂, to the electron beam landing pattern correction coils 11₁, 11₂.

A signal waveform of a deflection period in the line direction and a signal waveform of a deflection period in the field direction in the electron beams are supplied to the deflection yokes 30 (30₁, 30₂) and the correction current generating devices 12 (12₁, 12₂). The electron beam landing pattern correction coils 11 (11₁, 11₂) mounted on the respective neck portions 24 (24₁, 24₂) are comprised of a pair of electromagnetic coils 11A, 11B which are opposed to each other in the horizontal direction of the screen across the respective neck portions 24 (24₁, 24₂). The correction current generating devices 121, 122 or 123 shown in FIGS. 16, 17 or FIG. 18 respectively can be applied to the correction current generating devices 12₁, 12₂. The above-mentioned multi-neck type color cathode-ray tube 21 is assembled to make up a display apparatus such as a computer display, a television receiver and the like.

In accordance with the display apparatus including the multi-neck type color cathode-ray tube 21 according to the embodiment of the present invention, the electron beam landing pattern of each of the electron beams 29₁, 29₂ from the electron guns 26₁, 26₂ can be corrected independently. Accordingly, the electron beam landing pattern can be corrected in such a manner that the respective electron beams 29₁, 29₂ can impinge upon the same phosphor layer at the central portion of the large image area 32. Furthermore, according to this embodiment, there can be achieved other effects similar to those of the display apparatus which includes the color cathode-ray tube 1.

According to the present invention, difference in the electron beam landing position can be corrected in detail by setting corrected amounts corresponding to respective coordinates on the screen. Further, the electron beam landing can be corrected after the display apparatus has been manufactured. Furthermore, the temperature drift and the geomagnetic drift can also be corrected.

According to the present invention, when the fluorescent screen of the cathode-ray tube is produced, the curvature of the exposure lens can be simplified, the number of the lens systems can be reduced, the accuracy of the lens can be improved, and the optical design can be simplified. Furthermore, the design of the deflection yoke can be simplified.

The present invention is suitable as the application to the display apparatus including the multi-neck type color cathode-ray tube having a plurality of electron guns. Specifically, it becomes possible to correct the electron beam landing in such a manner that, the respective electron beams may be landing on the same phosphor layer of the fluorescent screen when the electron beams from the respective electron guns impinge upon the same place of the phosphor layer at the central portion on the screen. Therefore, according to the display apparatus of the present invention, there is displayed a high-quality image.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A display apparatus comprising:
electron beam landing pattern correction coils disposed at the rear sides of deflection yokes provided on a cathode-ray tube; and
correction current generating means for generating correction current corresponding to electron beam landing patterns to supply the current to said electron beam landing pattern correction coils, wherein
said correction current is generated by selectively combining a plurality of waveform current components which can respectively correct a plurality of fundamental electron beam landing patterns.

2. A display apparatus according to claim 1, wherein
said correction current is supplied to said electron beam landing pattern correction coils in synchronism with deflection periods of a line direction and a field direction of electron beams.

3. A display apparatus comprising:
electron beam landing pattern correction coils disposed at the rear sides of respective deflection yokes provided on a multi-neck type cathode-ray tube including a plurality of electron guns; and
correction current generating means for generating correction current corresponding to electron beam landing patterns from said plurality of electron guns to supply the current to said electron beam landing pattern correction coils, wherein
said correction current is generated by selectively combining a plurality of waveform current components which can respectively correct a plurality of fundamental electron beam landing patterns, and said electron beam landing patterns of electron beams from said plurality of electron guns can be corrected independently.

4. A display apparatus according to claim 3, wherein
said correction current is supplied to said electron beam landing pattern correction coils in synchronism with deflection periods of a line direction and a field direction of electron beams.

5. A method of correcting an electron beam landing pattern comprising the step of:
supplying a correction current selectively combined a plurality of waveform current components, which can respectively correct a plurality of fundamental electron beam landing patterns, to electron beam landing pattern correction coils disposed at the rear side of a deflection yoke provided on a cathode-ray tube in response to an electron beam landing pattern.

6. A method of correcting an electron beam landing pattern according to claim 5, wherein
said correction current is supplied to said electron beam landing pattern correction coils in synchronism with deflection periods of a line direction and a field direction of electron beams.
